(19) United States
(12) Patent Application Publication
(10) Pub. No.: US 2022/0023148 A1
(43) Pub. Date: Jan. 27, 2022

(54) LYOPHILISATE CONTAINER AND INFUSION KIT

(71) Applicant: HOFFMANN-LA ROCHE INC., Little Falls, NJ (US)

(72) Inventors: Carmen LEMA MARTINEZ, Basel (CH); Joerg LUEMKEMANN, Basel (CH); Thomas ZUMSTEIN, Basel (CH); Daniel KULLMANN, Zuerich (CH)

(21) Appl. No.: 17/296,763

(22) PCT Filed: Nov. 25, 2019
(86) PCT No.: PCT/EP2019/082340

§ 371 Date: May 25, 2021

(51) Int. Cl. A61J 1/20

(52) U.S. Cl. CPC A61J 1/2027; A61J 1/10; A61J 1/2093; A61J 1/2086

(57) ABSTRACT

A lyophilisate container (39) comprising a compartment; a wall (3119, 3129) limiting the compartment; and a lyophilisate arranged inside the compartment. At least a portion of the wall (3119, 3129) is semipermeable allowing vapour permeation in one direction out of the compartment through the wall (3119, 3129) and preventing vapour permeation in an opposite direction into the compartment through the wall (3119, 3129).

### TECHNICAL FIELD

The present invention relates to lyophilisate containers, infusion kits having such lyophilisate containers, methods of preparing such lyophilisate containers and use of such lyophilisate containers.

### BACKGROUND ART

In many chemical, pharmaceutical, nutritional and other applications substances are provided in a dry form. Thereby, in order to achieve a long shelf life, it is often aimed to have the substances as dry as possible. In this context, it is known to lyophilize or freeze dry the substances. Particularly, where it is necessary or beneficial to gently drying the substances, e.g. without heating them in an inappropriate manner, lyophilisation often is preferred.

For example, in many medical applications, pharmaceuticals or drug substances are to be, e.g., orally, parenterally, intravenously or subcutaneously, administered in liquid form. As an example, for intravenous administration it is known to use infusion bags which can be hanged on a support and continuously drop a liquid drug substance or a drug diluent mixture through an infusion needle into a patient. However, in connection with liquid drug substances, many pharmaceuticals and particularly biopharmaceuticals cannot be stored and supplied for an appropriate duration in liquid form since they commonly are unstable in that form. More specifically, many antibiotics or other biological drugs are unstable in liquid form such that their quality cannot be maintained as liquid. In particular, stress caused by shaking, microbiological growth, aggregation or the like may compromise the drugs. As mentioned, it is however known to supply the drug in a dry form, such as in a powder or the like, in which they are essentially more stable and robust compared to the liquid form. The dry drug formulation is then reconstituted or dissolved shortly before administration.

To achieve or maintain appropriate hygienic and quality standards the substances are often carefully lyophilised in specific conditions such as an aseptic environment. Thereby, the substances are usually lyophilised in specific containers from which they are transferred to other containers or packages for storage and supply. Shortly before being applied or administered the substances are then reconstituted. Typically, such procedure is rather elaborate and prone to mistakes. When transferring the substances, there may be a risk of loss or contamination. This can be of particular importance when the substances, such as highly potent drug substances, are provided at comparably small amounts and/or when precise amounts have to be handled. Also, this might endanger caregivers or clinicians when they need to prepare high potent drug substances and might get in contact with those. Usually comparably large efforts are made to protect the ones that need to prepare the drug substances for patients, for example by use of laminar air flow, isolator boxes, gloves over gloves and protective sleeves. Furthermore, particularly on an industrial level, preparation can be comparably inefficient. For example, typically the time required for lyophilisation is comparably high for different reasons.

Still further, when pharmaceuticals or drug substances are involved, the persons handling the substances can be confronted with comparably high demands. Therefore, such applications are often prone to mistakes particularly when comparably low skilled or low educated persons are involved. For example, when administration in an infusion bag is aimed, the preparation of the drug substance including its reconstitution and provision in the infusion bag is of utmost importance to assure an appropriate treatment. Particularly, where highly potent drug substances are involved the treatment by infusion may be inappropriate if it cannot be assured that the preparation is performed appropriately, such as it is often the case in rather low and middle income countries where appropriate clinical environments with aseptic conditions and/or laminar air flow are scarce. Also, in application where the speed of preparation is crucial such as in emergency situations, the known preparation of highly potent drug substances often is not appropriately efficient.

Therefore, there is a need for a system or process allowing an efficient life cycle of a consumable lyophilisate starting from its preparation and ending at its administration.

### DISCLOSURE OF THE INVENTION

According to the invention this need is settled by a lyophilisate container as it is defined by the features of independent claim 1, by an infusion kit as it is defined by the features of independent claim 13, by a method of preparing a lyophilisate container as it is defined by the features of independent claim 15, and by a use of lyophilisation container as it is defined by the features of independent claim 16. Preferred embodiments are subject of the dependent claims.

In one aspect, the invention is a lyophilisate container comprising a compartment, a wall limiting the compartment, and a lyophilisate arranged inside the compartment. At least a portion of the wall is semipermeable allowing vapour permeation in one direction out of the compartment through the wall and preventing vapour permeation in an opposite direction into the compartment through the wall.

Lyophilisation in the context of the present invention is a low temperature dehydration process, which involves freezing a substrate, lowering pressure and then removing ice by sublimation and desorption. The result from lyophilisation is the lyophilisate. Lyophilisation is also referred to as freeze drying. Lyophilisation can cover bulk freeze drying, which may produce lyophilized powders, microspheres, or spray drying.

The lyophilisate can, e.g., be a nutritional or dietary substance intended to be consumed by a person by drinking, eating or the like. It can also be an analytical substance or a substance to be used in a chemical process. However, preferably the lyophilisate is a lyophilised drug formulation, particularly, a highly potent drug formulation which can comprise a biological compound such as a monoclonal antibody, an antibody drug conjugate, an antibody fragment, a locked nucleic acid (LNA), gene vectors, virus like particles, or the like. Advantageously, the lyophilisate has a moisture range of less than about 3%, i.e. a water activity of less than about 0.05.

The term “drug” as used herein relates to a therapeutically active agent, also commonly called active pharmaceutical ingredient (API), as well as to a combination of plural such therapeutically active substances. The term also encompasses diagnostic or imaging agents, like for example contrast agents (e.g. MRI contrast agents), tracers (e.g. PET tracers) and hormones, that need to be administered in liquid form to the patient.

The term “drug formulation” as used herein relates to a single drug as defined above or a plurality of such drugs mixed or formulated. For example, besides the drug, a drug formulation may additionally comprise an excipient and/or other auxiliary ingredients. When being a dry drug formulation, the lyophilisate can be a solid, a semisolid or a powderous drug formulation.

The term “drug substance” as used herein relates to a drug formulation as defined above in a form that is suitable for administration to the patient. Thereby, the drug substance can be the pure drug formulation or a drug formulation reconstituted, diluted or dissolved in an administrable form. A particularly preferred drug substance in the context of the invention is a solution, in particular a solution for oral, parenteral intrathecal or ophthalmic administration, injection or infusion.

The term “drug product” as used herein relates to a finished end product comprising a drug substance or a plurality of drug substances. In particular, a drug product may be a ready to use product having the drug substance in an appropriate dosage and/or in an appropriate form for administration. For example, a drug product may include a handling or storage device such as a flexible container.

The term “potency” used in connection with the drug formulation can be a measure of drug activity expressed in terms of the amount required to produce an effect of given intensity. Thus, the terms “high potency”, “highly potent” or similar can relate to a formulation or substance which is active at comparably small amounts or dosages. In other words, a highly potent drug formulation can evoke a given response at comparably low concentration, while a drug formulation of lower potency can evoke the same response only at higher concentrations. The potency may depend on both the affinity and efficacy of the drug formulation. Thereby, such drug formulations or substances can be particularly problematic since comparably small variations in dosing or comparably small contaminations can be comparably effective.

In numbers, a highly potent drug formulation can be defined as a drug formulation having a biological activity at approximately 15 micrograms (μg) per kilogram (kg) of body weight or below in humans. This is equivalent to a therapeutic dose at approximately 1 milligrams (mg) or below in humans. The highly potent drug formulation can thus be defined as a drug having an inhalative Acceptable Daily Exposure (ADE) value of 1.5 μg/d or less, translating into an Indicative Occupational Exposure Limit (IOEL) value of 0.15 μg/m³. In particular, the highly potent drug formulation can be a class 3B drug or the like. When used with highly potent drug formulations to be administered by infusion, the method according to the invention can be particularly beneficial.

The term “compartment” in connection with the invention relates to any suitable interior in which the lyophilisate can be positioned or stored. It is or, at least, can be tightly closed such that the lyophilisate is protected from humidity, mechanical stress and contamination. The compartment can be formed by a soft, flexible, elastic or rigid structure of the container.

The term “wall” in connection with the structure forming the compartment can relate to any soft, hard, flexible or rigid structure suitable to form the compartment. It can be a single piece construction or a composition of plural differing parts. The wall can be semipermeable by being made of semipermeable material, by having a section of a semipermeable material or by a similar construction.

By providing the wall to be at least partially semipermeable to vapour and particularly to water vapour, it can be achieved that the final generation of the lyophilisate by freeze drying can be performed inside the container it will be supplied and, eventually, used with for administration. More specifically, the original drug formulation to be lyophilised can be positioned inside the container which is closed afterwards and then exposed to conditions inducing lyophilisation. During lyophilisation, the water or other vapour can escape the container through the wall. Thereby, it can be beneficial to have an as large portion of the wall to be semipermeable in order to achieve a highly efficient and fast lyophilisation.

By allowing lyophilisation inside the compartment, the container according to the invention achieves a reduction of the number and complexity of steps involved in preparation of the lyophilisate and its administration. Further, safety can be increased by reducing the risk of exposing the lyophilisate such that a high quality of the lyophilisate can efficiently be achieved.

Moreover, since the wall is only permeable for vapour from the inside to the outside but not from the outside to the inside, the lyophilisate inside the compartment can be well protected. This allows a secure storage and preservation of the lyophilisate until its administration. If desired, the wall allows an aseptic preservation of the lyophilisate inside the compartment.

Furthermore, the container also allows to protect caregivers or clinicians when they need to prepare high potent drugs. A desired reduction of exposure can easily be achieved and large efforts made for protection can be prevented or at least reduced. Thus, the container according to the invention allows for providing an efficient life cycle of the lyophilisate starting from its lyophilisation and ending at its administration.

Preferably, the wall of the container comprises a semipermeable membrane which is vapour permeable in the one direction and vapour tight in the other direction. The semipermeable membrane can have various different attributes. It can be pierceable, heat conductive, UV-tight, water vapour impermeable/selectively impermeable or combine plural of those or other attributes. Such membrane efficiently allows for achieving semipermeability of the wall. Moreover, the lyophilisate inside the compartment can efficiently and safely be administered. For example, the membrane can be pierced in order to provide a liquid into the compartment for dissolving the lyophilisate before administration. Additionally, the membrane can be used for filtering the lyophilisate solution which may result in a particulate free and pure liquid or solution to be administered.

Preferably, the wall comprises a frame structure, by means of which the semipermeable membrane is spanned and/or held. Such frame structure and membrane combination allows for providing the container in a predefined shape which may be adapted in accordance with the lyophilisate and its intended application or administration. In particular, the frame structure can provide for giving a certain stability and the membrane can provide the function of semipermeability

In a preferred embodiment, the lyophilisate container comprises an outer encasing and an inner encasing positioned inside the outer encasing, wherein the wall is a portion of the inner encasing. The outer encasing as well as the inner encasing can be essentially cylindrical, for example. In particular, the inner encasing can have a diameter which sufficiently smaller than a diameter of the outer encasing such that an appropriate room or volume is provided between the inner and outer encasings.

Having two encasings positioned inside each other and arranging the wall in the inner encasing allows for providing a comparably large area of the wall to be semipermeable and, anyway, to have a comparably robust container protecting the lyophilisate. Such large semipermeable area allows for efficient lyophilisation. Also, it allows for efficiently filtering a solution created by dissolving the lyophilisate inside the compartment.

More specifically, the inner encasing can have the frame structure spanning the semipermeable membrane. Thereby, the frame structure can be formed by a preferably flattened upper ring portion, a preferably flattened lower ring portion and a plurality of bars extending between the upper and the lower ring portions. The semipermeable membrane is spanned into the windows created by the upper and lower ring portions and the bars.

The used semipermeable membrane in the wall of the inner encasing can guide vapour either from the inside of the inner encasing to the outside and restricting the permeation of vapour to the inside of the inner encasing, or it can be attached reversed such that it allows water vapour to permeate from the outer barrier into the inside of the inner encasing but not from the inner encasing towards its outside.

The inner encasing and eventually also the outer encasing can be housed beneath a lid that is connected to the encasing(s), e.g., irreversibly. The lid, which may be part of the inner encasing unit, may join thus the inner encasing to the outer encasing. In the centre of the lid covering the inner encasing, a coupler can be embodied which is hollow and allows the transfer of substances into the inner encasing or out of it, respectively. This coupler can be part of the lid and designed to be closed by a removable and tight cap that protects the lyophilisate inside the container from environmental impairment or the leak of lyophilisate out of the container. Such coupler can not only be found on the lid that is connected to the inner encasing but it may also be found on the other end of the container on the bottom of the outer encasing. These couplers can house barriers as diaphragms or septa that need to be punctured by a needle or thorn. Yet, the coupler passage can be hollow as well, to facilitate a substance transfer without a restricting barrier.

The coupler on the lid of the inner encasing can be intended to be jointed to a flexible container, or to a pouch, bag, bottle, or other container. The identical coupler at the outer encasing can be used to attach the container to an empty other container, pouch, bag, or bottle to collect the dissolved lyophilisate, solution or drug substance which is freshly prepared or needs to be transferred. The coupler on the lid of the inner encasing and/or the coupler at the outer encasing can be connected to a container, pouch, bag, or bottle by a flexible tube. This flexible tube can provide another identical coupler that is the respective counterpart to the couplers on the lid or bottom of the container, respectively. By such a connection via a tube, a protected transfer from flexible container, pouch, bag, bottle or other container to the product containing container or vice versa can be ensured.

The outer encasing surrounding the inner encasing, which may comprise the comparably delicate frame structure and membrane, protects the housed lyophilisate also from degradation by permeation of water-vapour or oxygen, of UV-radiation and from excessive mechanical stress.

For bonding the inner encasing and the outer encasing several techniques can be applied. For example, threaded coupling, thrust coupling, snap or press-fit, adhesive bonding, ultrasonic welding, ultrasonic staking, electromagnetic welding or similar techniques that achieve hermetic and strong bonding but avoid quality impairment.

More specifically, in a variant of the preferred embodiment of the container, the compartment for the lyophilisate is arranged in between the outer encasing and the inner encasing. There at least a portion of the wall is oriented to allow vapour permeation in the one direction from the compartment to the inner encasing through the wall and to prevent vapour permeation in the opposite direction from the inner encasing to the compartment through the wall.

In such variant, the compartment is positioned in a space formed in between the outer and inner encasings. Thereby, the lyophilisate can be filled and/or generated by filling the outer encasing with the desired substance solution before the inner frame is plugged or positioned into it. After filling, further product optimizations or product protection steps can take place, particularly including lyophilisation to remove excess liquid. Also, the container inside can be flushed with inert gas, the container can be evacuated to remove undesired gases, or other techniques prolonging and ensuring the stability and efficacy of incorporated substances or drugs can be applied. The lyophilisation and flushing or evacuation optimizations are intended to take place when the outer encasing and the inner encasing are associated to each other already. Thereby, the wall allows for permeation of water vapour out of the outer encasing through the inner encasing. If the inner encasing is provided with the frame structure mentioned above, in this variant, the membrane advantageously is arranged around the inner encasing. Like this, it can be achieved that only the membrane is in contact with the lyophilisate or any component used for generating or reconstituting it and not any portion of the frame structure.

In another variant of the preferred embodiment of the container, the compartment is arranged in the inner encasing, and there at least a portion of the wall is oriented to allow vapour permeation in the one direction. The vapour is intended to flow from the inner compartment to the space between the outer encasing and the inner encasing through the wall and to prevent vapour permeation in the opposite direction from the space between the outer encasing and the inner encasing towards the inner compartment through the wall.

Thereby, the lyophilisate can be filled and/or generated inside the inner encasing by filling the inner encasing with a solution upfront marriage of the inner encasing and the outer encasing. After the filling, the optimizations mentioned above can be performed at least including lyophilisation to remove excess liquid. The optimization may be performed when the inner encasing is in the outer encasing or when being positioned outside of it. If the inner encasing is provided with the frame structure mentioned above, in this other variant, the membrane advantageously is arranged within the inner encasing covering the frame structure. Like this, it can be achieved that only the membrane is in contact with the lyophilisate or any component used for generating or reconstituting it and not any portion of the frame structure.

In all variants of the preferred embodiment of the container, the outer encasing or the inner encasing preferably has a conical lateral area. Thereby, the term “lateral area” can relate to a surface or area of the outer or inner encasing which surrounds the outer or inner encasing. It can be the final outer area or surface of the container.

By having such a conical area, it can be achieved that plural encasings are arranged side by side, wherein there still is some free space between them. More specifically, in the variant where the compartment is between the outer and inner encasings, the outer encasing advantageously has the conical lateral area. In the other variant where the compartment is inside the inner encasing, the inner encasing advantageously has the conical lateral area. This allows for efficiently circulating heat and/or cold around the encasings and for efficiently removing sublimed water vapour from the walls of the containers next to each other, e.g., when being placed on a lyophilisation shelve. Like this, a particularly beneficial temperature transfer and water vapour removal can be achieved which allows for increasing the efficiency of lyophilisation inside the container. Particularly, on an industrial level where it is desired to prepare a comparably high number of containers in parallel, this can be highly beneficial.

In another preferred embodiment, the lyophilisate container comprises a rigid body having a hole opening at one end side of the body and extending from the one end side of the body or container body to the other end side of the container body, wherein the hole forms the compartment and the semipermeable membrane attached to the container body thereby closing the hole at the one end side of the container body. The hole can also end in a second opening at the other end side of the body. In such embodiments, the hole is a through-hole. Alternatively, the hole can be closed at the other end side such that it is a blind hole.

Such container can allow for providing a particularly robust and at the same time simple construction. By covering the inside forming the compartment with the membrane, an efficient lyophilisation can be performed inside the container. Also such semipermeable membrane covering the hole can efficiently be used to filter a solution created by dissolving the lyophilisate inside the compartment.

The rigid body or container body can be made of any suitable plastic or other material. It can be manufactured in a blow fill and seal, deep draw moulding or other process. More specifically, such container can be manufactured by punching a cylindrical hole into the a top part of a formed deep draw mould that is then covered and welded to a semipermeable membrane or porous foil facilitating the evaporation of water out of the compartment and protecting the inside of the moulded form from permeation of water.

The container or container body can further be manufactured by turning the deep draw moulded container body upside down, such that the punched opening is directed towards the ground and the open bottom end is facing upwards. The semipermeable membrane can then be attached to the inside of the body or container body beneath the punched hole. Subsequently to the placing and welding of the membrane to the punched opening, the body or container body is filled with the desired raw substance. This means that the opening on the bottom or bottom side of the body is used for filling while it is directed upwards. The lyophilisation or freeze drying to remove excess liquid can be performed before or, particularly, after the container is closed.

Advantageously, the rigid body or container body is essentially cylindrical or hollow cylindrical. The term “essentially cylindrical” also covers forms slightly deviating from a geometrical cylinder. In particular, a cylinder being conical to a certain extent may still be essentially cylindrical. E.g., a conical cylinder having a sidewall slanted to a maximum of about 5°, about 3° or about 2° can still be essentially cylindrical. Also, the sidewall of the tubular cartridge may differ to a certain extent from a geometrical straight shape. The tubular cartridge can be embodied as a hollow cylinder wherein the open end is located at one end of the cylinder.

When the hole is a through-hole also having an opening on the other end side of the body or container body, the other end side can also be provided with a semipermeable membrane. However, preferably, the lyophilisate container comprises a non-permeable foil having a high thermal conductivity, the foil being attached to the body or container body thereby closing the through-hole at the other end side of the body or container body. The term “high thermal conductivity” can relate to a property of the non-permeable foil allowing an efficient heat or cold transfer into the compartment. Particularly, the thermal conductivity of the non-permeable foil can be high compared to the thermal conductivity of the body.

More specifically, during manufacturing of the container or container body, the opening at a bottom end or other end side may be closed with the non-permeable foil. The foil can be a pierceable or peelable foil. The attached peelable foil allows the storage of the lyophilisate in the container until a transfer of the lyophilisate into another container or a direct reconstitution thereof is intended. Thereto the foil can be removed from the container by peeling. Alternatively, the pierceable foil can facilitate the dissolution of the lyophilisate, e.g., by a needle set attached to the container and forcing liquid into it.

The removal of the dissolved lyophilisate can be performed on the end side provided with the semipermeable membrane. Therefore, a connector can be attached facilitating the linkage of an empty container that collects the freshly prepared solution and readies it for transport. In particular, the dissolved solution can be filtered via the semipermeable membrane achieving a particulate free solution, e.g., administrable for parenteral applications when transferred into the collector container.

Preferably, the body or container body has a conical lateral area. The lateral area of the body or container body can be the outer surface of the body or container body. The conical lateral area can also be embodied over a portion of the body only such that it has straight and conical sections. As mentioned above, even when the lateral area is conical, i.e. being completely widening or having widening section(s), it can still be essentially cylindrical since its main appearance can still be as a cylinder.

In use, the end side of the body having the smaller outer diameter can be the upper end side. The end side of the body with the larger outer diameter can be the lower end side. By positioning the body on the lower end side it can stand comparably stably.

Similar as described above, by such a conical area it can be achieved that plural containers or container bodies are arranged side by side, wherein still there is some free space between them. This allows for efficiently circulating heat and/or cold around the container. Like this, a particularly high temperature transfer can be achieved which allows for increasing the efficiency of lyophilisation inside the container. Particularly, on an industrial level where it is desired to prepare a comparably high number of containers in parallel, this can be beneficial.

In still another preferred embodiment, the lyophilisate container is a pad-like structure, wherein the compartment is formed in between two sheets and at least one of the two sheets is the wall, i.e. at least partially is semipermeable. The pad-like structure can be a pouch or cushion-shaped element which has the two sheets forming an interior in which the compartment is formed. In order to form a pad-like structure the two sheets can be connected along their edges, e.g., by forming respective seal seams along the edges. The two sheets can be two separate or separable units as well as one unit folded to form the two neighbouring sheets. The two sheets can be made of any suitable plastic, metallic, composite or other material which advantageously is flexible. Advantageously, the pad-like structure is made in a blow fill and seal process. The pad-like structure could be generated also by deep mould drawing similar to the process of the manufacturing of blister foils. The notches could then be filled, frozen and then sealed with a semipermeable membrane, or filled, sealed with a semipermeable foil or the like and then transferred into a freeze dryer.

Such pad like structure allows for providing a comparably simple construction having a comparably large semipermeable area. Like this, an efficient lyophilisation inside the compartment can be performed. Also, when being prepared before administration the lyophilisate can efficiently be reconstituted and, eventually, filtered through the semipermeable portion of the wall. For example, for providing a diluent into the compartment, one of the sheets can be pierced or ruptured.

In another aspect, the invention is an infusion kit comprising a lyophilisate as described above, a lyophilised drug formulation positioned in the lyophilisate container and a flexible container having a first compartment filled with a reconstitution liquid and a port.

The reconstitution liquid can be any liquid suitable to reconstitute the lyophilised drug formulation. It can particularly be a diluent such as a physiological solution such as a sodium chloride (NaCl) solution, a sucrose solution, an aqueous dextrose or any other similar solution. The NaCl solution can, e.g., be a 0.9% NaCl solution. The sucrose solution can, e.g., be a 5% sucrose solution. The aqueous dextrose can, e.g., be a 10% dextrose solution.

The term “flexible” as used in connection with the material or the container can relate to a comparably soft material which is not shape stable. Particularly, such material does usually not keep its shape when being differently positioned or oriented. Typical flexible materials are foils and particularly plastic foils or foil like structures such as tight meshes or the like.

The flexible container can be manufactured as follows: The first compartment of the flexible container is formed out of a flexible sheet-like material. The reconstitution liquid is filled into the first compartment of the flexible container and the first compartment is sealed. The flexible container can particularly be manufactured within a side fill and seal or a blow fill and seal process.

The term “sheet-like” as used in connection with the material the flexible container can be made of relates to a flat typically essentially even substrate having a thickness which is considerably smaller than its length and width. In particular, the sheet-like material can be a foil or a similar structure.

The sheet-like material can be a sheet-like single plastic, composite, plastic blend or multilayer plastic. It can be altered in its surface properties to improve extractability, to reduce or exclude gas permeation and leaching of additives and/or to simplify sealing. The sheet-like material needs to be compatible with its intended purpose such as compatible with parenteral or oral solutions, nonreactive when chemicals are stored in the flexible container and/or aligned to required guidelines applicable to the drug substance, e.g., the guidelines of the Unites States Food and Drug Administration (FDA) or the guidelines of the European Medicines Agency (EMA).

The term “sealing” as used herein relates to a process or step of attaching two or more elements or portions of an element to each other such that a gas, a liquid or another fluid cannot pass the attached portions. In embodiments where the flexible sheet-like material is a foil and particularly a plastic foil, the sealing can be provided by applying a predefined temperature and/or pressure at a particular location of the foil. Thereby, the foil can be coated with an adhesive which activates its adhesive properties by application of temperature and/or pressure. Alternatively or additionally, the sealing can involve ultrasound-, high frequency- and or radio frequency welding. In particular, sealing can involve creating seal seams. The seal seams can be embodied as firm seals and/or frangible seal.

The first compartment of the flexible container can be sized to have a volume in a range of about 20 ml to about 2′000 ml.

The flexible container can consist of two identical sheet-like materials or of two different sheet-like materials. For example, one sheet-like material may be transparent while the other one may be aluminized to reduce the ingress of water vapour or oxygen.

The port can be of any kind suitable for the intended application of the kit. For example, a port can be or comprise a long cylindrical opening or a septum that enables withdrawal of liquid while assuring protection from unintended spilling. These withdrawal ports are usually found in infusion bags, septum bottles, or squeeze pouches for nutrition. The ports can be placed between the open layers or sheets of the flexible container prior sealing them, or can be attached after the layers or sheets were sealed with each other. Other ports can be attached in the proximity of the port or on the opposing border of the flexible container. Also, ports can be placed into the edges of a vertical line or seam seal directed from top to bottom. To facilitate the attachment of ports on the lateral edges of the flexible sheets forming the flexible container, punctures in the sheet can be required where ports can be placed prior the final welding of the flexible container takes place. The port/ports within the flexible container can manage the connectability to other containers or to devices used for administering or provision of the content of the flexible container.

In addition to the port, other ports can be attached in the proximity of the port or on the opposing border of the flexible container. Also, ports can be placed into the edges of a vertical line or seam seal directed from top to bottom. To facilitate the attachment of ports on the lateral edges of the flexible sheets forming the flexible container, punctures in the sheet can be required where ports can be placed prior the final welding of the container takes place. The port/ports within the flexible container can manage the connectability to other containers or to devices used for administering or provision of the content of the flexible container.

The kit allows for providing a ready to use system such as an infusion system having all components required for administration of the drug formulation by infusion. In particular, the flexible container can be an infusion bag.

It is also possible to provide multiple lyophilisate containers in the kit together with one single flexible container. Like this, a practitioner can be given the option to adjust the dosage by dissolving an appropriate amount of lyophilisates. Also, the administration of combination drug substances that can't be stored together but need to be administered or applied in parallel can be achieved. Furthermore, a stepwise activation of a process can be realised. For connecting the plural lyophilisate containers together, it can, e.g., be provided with an adapter or an intermediate piece. The final combination can then be similarly connected to the flexible container.

In a preferred embodiment, the flexible container comprises a second compartment separated from the first compartment by a frangible seal and the lyophilisate container is arranged inside the second compartment of the flexible container.

Such multiple compartments can be manufactured by—in addition to the steps mentioned above—forming a second compartment of the container out of the flexible sheet-like material and filling a lyophilisate container into the second compartment. The frangible seal can be embodied to open when the first compartment is, e.g. manually, compressed.

Any number of compartments can be positioned anywhere in the container. For example, for allowing a particularly efficient filling, the compartments can all extent to one side edge of the container such that the compartments may be filled from one side only. Or, for achieving a safe application of the container such as a particular sequence of activation, the compartments can be distributed in the container such as on opposite side edges thereof.

The term “frangible seal” relates to a connection of the two opposing flexible sheets in the flexible sheet-like material which can be released, broken or ruptured when compressing a compartment adjacent to the frangible seal. Frangible seals can also be referred to a peelable seal, non-permanent weak seal or breakable seal.

Similar as the first compartment, also the second compartment can have a volume in a range of about 20 ml to about 2′000 ml.

Specifically, forming the first and second compartments can be embodied by positioning two foils or sheets at each other and then sealing the two foils along the edges of the foils or at any other appropriate portion. Alternatively or additionally, one single foil or sheet can be folded in a suitable manner and then sealed along the edges of the foil or at any other appropriate portion. In the end the container can be a bag or bag-like device such as an infusion bag, a pouch or similar.

Such multi compartment flexible container allows for providing a closed ready to use system which can conveniently and quickly be prepared prior administration without risking any contamination or loss of the drug substance. In particular, prior administration the seal between the first and second compartments can be opened by manually compressing the first compartment. Then the liquid or diluent can be provided into the lyophilisate container. For that purpose the lyophilisate container can be broken or ruptured, e.g., by manually compressing it. Or, the structure can be provided in the second compartment allowing for opening, cutting, piercing or breaking the lyophilisate container. Or, the lyophilisate container can be coupled to the frangible seal such that when opening the frangible seal, the lyophilisate container is opened as well.

In an other preferred embodiment, the lyophilisate container is embodied in the port of the flexible container. Like this, it can be achieved that when providing the liquid out of the port it dissolves the lyophilisate and forms a solution to be administered, e.g., by infusion.

In still another preferred embodiment, the port has a first mounting structure and the lyophilisate container has a corresponding second mounting structure such that the lyophilisate container is mountable to the flexible container to expel the liquid through the lyophilisate container. Again, this allows for providing the liquid out of the port such that it dissolves the lyophilisate and forms a solution to be administered, e.g., by infusion.

In a further other aspect, the invention is a method of preparing a lyophilisate container as described above. The method comprises the steps of: (i) positioning a moist substance inside a compartment of the container limited by a wall limiting the compartment, wherein at least a portion of the wall is semipermeable allowing vapour permeation in one direction out of the inside of the compartment through the wall and preventing vapour permeation in an opposite direction into the inside of the compartment through the wall; (ii) closing the compartment of the container; and (iii) lyophilising the moist substance in the compartment such that vapour permeates out of the inside of the compartment through the wall.

The moist substance can be a solution of the substance, a semisolid, a pasty substance or a solid substance. In particular, not only liquid solutions can be filled into the compartment, it is also possible to include pre-processed materials in the means of syrups, granulates, microtablets, spray freeze-dried powders, free flowing pre-lyophilized spheres, active pre-lyophilized dry powder or differently manufactured substances.

Such method allows for efficiently preparing the lyophilisate container also on an industrial level. Moreover, such method can be applied in a variety of fields such as in nutrition, pharmacy and others.

In still a further other aspect, the invention is a use of a lyophilisate container as described above. The use comprises the steps of reconstituting the lyophilisate of the lyophilisate container in a liquid inside the compartment of the lyophilisate container, and filtering the liquid solution comprising the reconstituted lyophilisate through the wall of the compartment.

Such in-container reconstitution allows for a particularly protected and safe preparation of the solution to be administered. The filtering of the prepared solution through the wall and particularly its semipermeable portion allows for providing a clean particulate free solution as it is beneficial, e.g., in medical applications such as in administration by infusion.

As mentioned, the invention in all aspects is designed to be used in the fields of nutrition, chemistry and diagnostics but primarily intended for medical or pharmaceutical applications.

### BRIEF DESCRIPTION OF THE DRAWINGS

The lyophilisate container according to the invention, the kit according to the invention, the method of preparing a lyophilisate container according to the invention and the use according to the invention are described in more detail herein below by way of an exemplary embodiment and with reference to the attached drawings, in which:

FIG. 1 shows a perspective view of a first embodiment of a kit according to the invention having a first embodiment of a lyophilisate container according to the invention;

FIG. 2 shows a perspective view of a second embodiment of a kit according to the invention having a second embodiment of a lyophilisate container according to the invention;

FIG. 3 shows a perspective view of a third embodiment of a kit according to the invention having a third embodiment of a lyophilisate container according to the invention;

FIG. 4 shows a perspective view of a fourth embodiment of a kit according to the invention having a fourth embodiment of a lyophilisate container according to the invention;

FIG. 5 shows a perspective view of some components of a fifth embodiment of a kit according to the invention having a fifth embodiment of a lyophilisate container according to the invention;

FIG. 6 shows an exploded perspective view of some components of a sixth embodiment of a kit according to the invention having a sixth embodiment of a lyophilisate container according to the invention; and

FIG. 7 shows the kit of FIG. 6 while a lyophilisate is reconstituted and transferred from one compartment of a flexible container to another one.

### DESCRIPTION OF EMBODIMENTS

In the following description certain terms are used for reasons of convenience and are not intended to limit the invention. The terms “right”, “left”, “up”, “down”, “under” and “above” refer to directions in the figures. The terminology comprises the explicitly mentioned terms as well as their derivations and terms with a similar meaning. Also, spatially relative terms, such as “beneath”, “below”, “lower”, “above”, “upper”, “proximal”, “distal”, and the like, may be used to describe one element's or feature's relationship to another element or feature as illustrated in the figures. These spatially relative terms are intended to encompass different positions and orientations of the devices in use or operation in addition to the position and orientation shown in the figures. For example, if a device in the figures is turned over, elements described as “below” or “beneath” other elements or features would then be “above” or “over” the other elements or features. Thus, the exemplary term “below” can encompass both positions and orientations of above and below. The devices may be otherwise oriented (rotated 90 degrees or at other orientations), and the spatially relative descriptors used herein interpreted accordingly. Likewise, descriptions of movement along and around various axes include various special device positions and orientations.

To avoid repetition in the figures and the descriptions of the various aspects and illustrative embodiments, it should be understood that many features are common to many aspects and embodiments. Omission of an aspect from a description or figure does not imply that the aspect is missing from embodiments that incorporate that aspect. Instead, the aspect may have been omitted for clarity and to avoid prolix description. In this context, the following applies to the rest of this description: If, in order to clarify the drawings, a figure contains reference signs which are not explained in the directly associated part of the description, then it is referred to previous or following description sections. Further, for reason of lucidity, if in a drawing not all features of a part are provided with reference signs it is referred to other drawings showing the same part. Like numbers in two or more figures represent the same or similar elements.

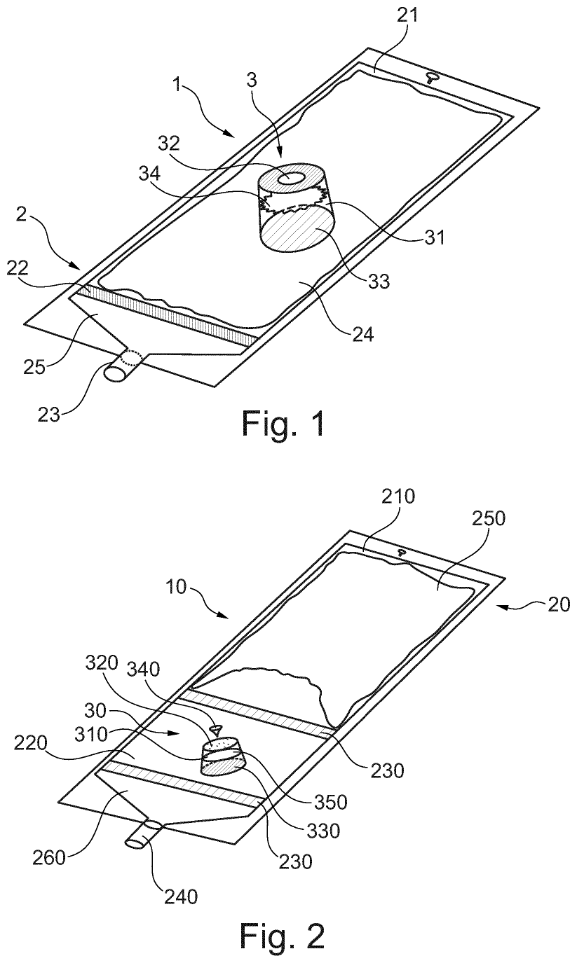

FIG. 1 shows a first embodiment of a kit 1 according to the invention which includes a flexible container in the form of an infusion bag 2 and a lyophilisate container 3 according to the invention. The infusion bag 2 has a first compartment 21 housing a liquid diluent 24. Inside the first compartment 21 the lyophilisate container 3 is positioned, which houses a highly potent lyophilized drug formulation 34 as lyophilisate. In a front section, the flexible container 2 has an outlet compartment 25 separated from the first compartment by a frangible seal 22. The compartments 21, 25 are formed in two sheets of a flexible plastic material by providing firm seals along the edges and the frangible seal 22 in an appropriate manner. In particular, the first compartment 25 is formed by firm seals at the outer edges of the sheets and the frangible seal 22. The outlet compartment 25 is formed by a front firm seal and the frangible seal 22 at its back end. Centrally in the front firm seal a port 23 is mounted which is in fluid connection with the outlet compartment 25. The port 23 is embodied to be connected to a structure or device for intravenous administration.

The lyophilisate container 3 has an essentially cylindrical rigid body 31 through which an axial through-hole extends. At a bottom end, the through-hole is closed by a non-permeable or tight foil 33. At about the upper end of the through-hole, a semipermeable membrane 32 closes the through-hole. Thus, a compartment is formed inside the through-hole between the foil 33 and the membrane 32, in which the lyophilized drug substance is arranged.

In use of the infusion bag 2, a user manually opens the compartment of the lyophilisate container 3. This can, e.g., be done by pushing on the foil 31 until it breaks. Or, it can be done by squeezing the container 3 or flexible container 2 such that an increase in distance between membrane 32 and the foil 33 is achieved and the membrane 32 and foil 33 are peeled off the container 3. Then the diluent 24 streams into the compartment and dissolves the drug formulation 34 such that a drug solution is obtained. The dissolving of the drug formulation 34 can be assisted by the user shaking the infusion bag 1 in case that the drug substance is not prone to shaking movements. Then the user compresses the first compartment 21 such that the pressure inside the first compartment 21 rises. Caused by this pressure rise, the frangible seal 22 ruptures such that the first compartment 21 and the outlet compartment 25 form a common compartment. The infusion bag 1 is then hanged port 23 down on a support and an intravenous device is attached to the port 23. Thereby, the infusion bag 1 is changed to a single compartment infusion bag and can be applied as known in the art.

In FIG. 2 a second embodiment of a kit 10 according to the invention which includes a flexible container in the form of an infusion bag 20 and a lyophilisate container 30 according to the invention is shown. The infusion bag 20 has a first compartment 210 housing a liquid diluent 250, a second compartment 220 housing the lyophilisate container 30 in which a highly potent lyophilized drug formulation 350 as lyophilisate is positioned, and an outlet compartment 260 in a front section of the flexible container 20. The first compartment 210, the second compartment 220 and the outlet compartment 260 are separated from each other by frangible seals 230. The compartments 210, 220, 260 are formed in two sheets of a flexible plastic material by providing firm seals along their edges and the frangible seals 230 in an appropriate manner. Centrally in the front firm seal a port 240 is mounted which is in fluid connection with the outlet compartment 260. The port 240 is embodied to be connected to a structure or device for intravenous administration.

The lyophilisate container 30 has an essentially cylindrical rigid body 310 through which an axial through-hole extends. At a bottom end, the through-hole is closed by a non-permeable or tight foil 330. At a top end the through-hole is closed by a semipermeable membrane 320. Thus, a compartment is formed inside the through-hole between the foil 330 and the membrane 320, in which the lyophilized drug substance is arranged. Furthermore, a thorn 340 is positioned at the upper sheet inside the second compartment.

In use of the kit 10, a user manually opens the compartment of the lyophilisate container 30 by pressing the thorn 340 into the foil 310. Then the user manually compresses the first compartment 210 of the infusion bag 20 such that the frangible seal between the first and second compartments 210, 220 opens. The diluent 250 streams into the second compartment 220 and dissolves the drug formulation 350 inside the compartment of the lyophilisate container 30 such that a drug solution is obtained. The dissolving of the drug formulation 350 can be assisted by the user shaking the infusion bag 10 in case that the drug substance is not prone to shaking movements. Then the user compresses the second compartment 220 such that the right frangible seal 230 ruptures and the first compartment 210, the second compartment 220 and the outlet compartment 260 together form a common compartment. The infusion bag 10 is then hanged port 240 down on a support and an intravenous device is attached to the port 240. Thereby, the infusion bag 10 is changed to a single compartment infusion bag and can be applied as known in the art.

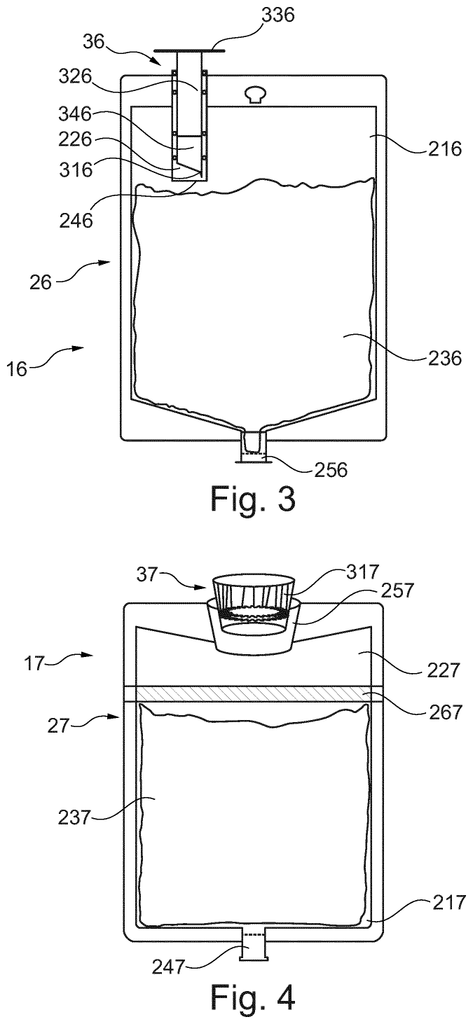

FIG. 3 shows a third embodiment of a kit 16 according to the invention which includes a flexible container in the form of an infusion bag 26 and a lyophilisate container 36 according to the invention. The infusion bag 26 has a first compartment 216 housing a liquid diluent 236. The first compartment 216 is generated by sealing two sheets of a flexible plastic material at their peripheral edges. In particular, firm seal seams are established along the edges.

In a front section of the flexible container 26 a lyophilisate container 36 is placed in a receiver plug 226, which is in fluid connection with the first compartment 216. The lyophilisate container 36 has a cylindrical shape and is dimensioned corresponding to the receiver plug 226. In particular, the lyophilisate container 36 is dimensioned to suit into the receiver plug 226. More specifically, it is inserted to a certain extent into the receiver plug 226 close to a separating barrier 246. At its bottom end it is closed by a non-permeable peelable foil 336. In between the foil 336 and a pointy tapered thorn 316 a lyophilisate compartment 246 is formed which houses a highly potent lyophilized drug formulation 326 as lyophilisate.

In use of the infusion bag 26, a user manually pushes the lyophilisate container 36 into the port 226. Thereby, the thorn 316 of the lyophilisate container 36 ruptures the membrane 246 such that the diluent flows into the compartment 326 of the lyophilisate container 36. Thereby, the drug formulation 326 is reconstituted and a drug solution is generated inside the infusion bag 26. After ensuring that the solution is completely mixed, the port 256 is connected to an intravenous device. Thereby, the infusion bag 26 can be applied as a known single compartment infusion bag.

In FIG. 4 a fourth embodiment of a kit 17 according to the invention which includes a flexible container in the form of an infusion bag 27 and a lyophilisate container 37 according to the invention is shown. The infusion bag 27 has a first compartment 217 housing a liquid diluent 237, a second compartment 227 with a receiver plug 257. The first compartment 217 and the second compartment 227 are separated from each other by a frangible seal 267. Otherwise, the compartments 217, 227 are formed in two sheets of a flexible plastic material by providing firm seals along the edges and the frangible seal 267 in an appropriate manner. Centrally, a port 247 is provided to the first compartment 217 which is in selective fluid connection with the first compartment 217. The port 247 is embodied to be connected to a structure or device for intravenous administration.

In use, the lyophilisate container 37 is plugged into the receiver plug 257 and opened towards the second compartment 227. By this insertion the lyophilisate container 37 and the compartment 227 create a through-hole that enables the connection of those two. Then, the user compresses the first compartment 217 such that the frangible seal 267 opens and one single common compartment is generated. Then the diluent is mixed with a drug formulation 317 initially located inside the lyophilisate container 37 such that a drug solution is generated inside the common compartment.

All seals involved in the embodiments of flexible containers described herein can be obtained by a process or step of attaching two or more elements or portions of a flexible sheet-like material such that a gas, a liquid or another fluid cannot pass the attached portions. In embodiments where the flexible sheet-like material is a foil and particularly a plastic foil, the sealing can be provided by applying a predefined temperature/energy and/or pressure at a particular location of the foil. Thereby, the foil can be coated with an adhesive which is thermo- and or pressure-activatable. Alternatively or additionally, the sealing can involve ultrasound-, high frequency- and or radio frequency welding. In order to generate firm seals and frangible seals the temperature/energy and/or pressure can be adjusted such that the aimed properties result.

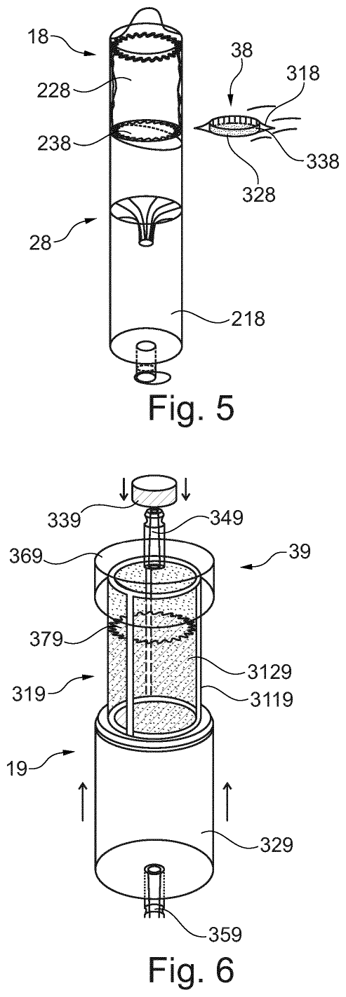

FIG. 5 shows a fifth embodiment of a kit 18 according to the invention which includes a flexible container in the form of an infusion bag, a tube 28 and a pad 38 as a lyophilisate container according to the invention. The tube 28 has a lower collecting compartment 218 and an upper flushing portion 228. In the flushing portion 228 there is a receptacle slit 238. The pad 38 comprises an upper flexible sheet 318 and a lower flexible sheet 328 as wall which are attached to each other by peripheral seal seams along the edges. The lower flexible sheet 328 comprises a semipermeable membrane allowing vapour permeation out of the compartment. Between the sheets 318, 328 a compartment is formed in which a lyophilized drug formulation 338 is arranged as lyophilisate.

In use, the pad 38 is introduced into the slit 238 and the upper sheet 318 is pierced or stripped. Then a diluent is flushed from the flushing portion 228 through the pad 38 which dissolves the drug formulation 338. The solution is then filtered through the semipermeable membrane of the lower sheet 328 and gathered in the collecting compartment 218. As the need may, an additional pad having the same drug formulation can then be processed the same way to adjust a dosage of the drug formulation in the solution gathered in the collecting compartment 218 and/or an additional pad having another substance can be processed the same way to generate a combined drug formulation solution in the collecting compartment 218. The lower end of the tube 28 is provided with a connector or port to be coupled to an infusion bag or the like.

In FIG. 6 a sixth embodiment of a kit 19 according to the invention which includes a flexible container in the form of an infusion bag and a lyophilisate container 39 according to the invention is shown. The lyophilisate container 39 has a cylindrical inner encasing 319 and a cylindrical outer encasing 329. The inner encasing 319 consists of a frame structure 3119 by means of which a semipermeable membrane 3129 is spanned. Thereby, the semipermeable membrane 3129 covers the interior of the frame structure 3119. In particular, the frame structure 3119 is embodied with a flattened top ring, a flattened bottom ring and vertical bars extending between and connecting the rings. Furthermore, the bottom ring is equipped with a transparent and heat conducting foil such that a compartment is generated in the inner encasing 319 in which a lyophilized highly potent drug formulation 379 is positioned as lyophilisate and such that a visual control as well as an improved heat transfer can take place. By the positioning of the membrane 3119 the drug formulation 379 is only in contact with the membrane 3119 but not with the frame structure 3129. The top ring is open such that the interior of the inner encasing 319 is accessible top down. The semipermeable membrane 3129 is oriented such that vapour can escape from the inside of the inner encasing 319 but permeation of vapour to the inside of the inner encasing 319 is restricted or prevented.

The outer encasing 329 consists of a rigid cylinder having a bottom and an open upper end side. The inner encasing 319 is coaxially plugged into the outer encasing 329. The inner and outer encasings 319, 329 are dimensioned in a way that there is a free room or volume between the inner encasing 319 and the outer encasing 329.

The inner and outer encasings 319, 329 are coupled to each other by an outer lid 369. Further, there is an inner lid 339 provided to the inner encasing 319 that in its centre is connected to a top coupler 349. The top coupler is hollow and allows the transfer of substances into the inner encasing 319. At the bottom of the outer encasing 329 a bottom coupler 359 is provided.

In preparation of the lyophilisate container 39, the drug formulation 379 is lyophilized inside the inner encasing 319. Thereby, vapour escapes through the membrane 3129 and also possibly through the top coupler 349. More specifically, since the overall area of the membranes 3129 is comparably large and due to the close contact between the drug formulation 379 and a freeze drying shelve, an efficient lyophilisation can be achieved.

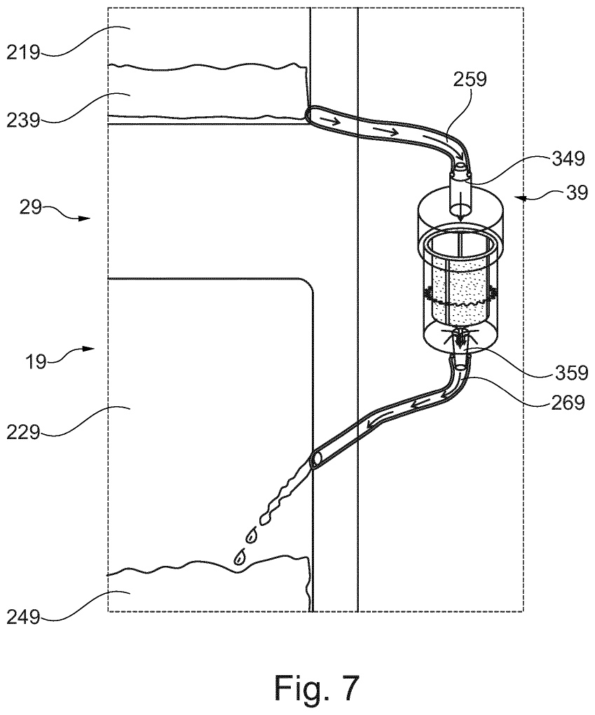

As shown in FIG. 7, in use, the lyophilisate container 39 is plugged to an infusion bag 29 as flexible container by means of the top coupler 349 and its bottom coupler 359. More specifically, the infusion bag 29 has a first compartment 219 filled with a diluent 239 and a second compartment 229. The diluent 239 is provided from the first compartment 219 via a first tube and the top coupler 349 into the inner encasing 319, where the drug formulation 379 is dissolved. The created drug solution 249 is then filtered through the membrane 3129 into the room between the inner encasing 319 and the outer encasing 329. From there it is provided through the bottom coupler 359 and a second tube 269 into the second compartment 229 of the infusion bag 29 where it is collected.

In an alternative use, multiple containers 39 are coupled in a sequence to the infusion bag. Thereby, the containers can be filled with the same drug formulation 379 to adjust the dosage within the drug solution or with a different drug formulation to be mixed with the drug formulation 329.

This description and the accompanying drawings that illustrate aspects and embodiments of the present invention should not be taken as limiting-the claims defining the protected invention. In other words, while the invention has been illustrated and described in detail in the drawings and foregoing description, such illustration and description are to be considered illustrative or exemplary and not restrictive. Various mechanical, compositional, structural, electrical, and operational changes may be made without departing from the spirit and scope of this description and the claims. In some instances, well-known circuits, structures and techniques have not been shown in detail in order not to obscure the invention. Thus, it will be understood that changes and modifications may be made by those of ordinary skill within the scope and spirit of the following claims. In particular, the present invention covers further embodiments with any combination of features from different embodiments described above and below. For example, whereas most examples described above are involving a drug formulation it is possible to operate the invention as well in non pharmaceutical applications such as in nutrition, chemical processes, analytical methods or similar.

The disclosure also covers all further features shown in the Figs. individually although they may not have been described in the afore or following description. Also, single alternatives of the embodiments described in the figures and the description and single alternatives of features thereof can be disclaimed from the subject matter of the invention or from disclosed subject matter. The disclosure comprises subject matter consisting of the features defined in the claims or the exemplary embodiments as well as subject matter comprising said features.

Furthermore, in the claims the word “comprising” does not exclude other elements or steps, and the indefinite article “a” or “an” does not exclude a plurality. A single unit or step may fulfil the functions of several features recited in the claims. The mere fact that certain measures are recited in mutually different dependent claims does not indicate that a combination of these measures cannot be used to advantage. The terms “essentially”, “about”, “approximately” and the like in connection with an attribute or a value particularly also define exactly the attribute or exactly the value, respectively. The term “about” in the context of a given numerate value or range refers to a value or range that is, e.g., within 20%, within 10%, within 5%, or within 2% of the given value or range. Components described as coupled or connected may be electrically or mechanically directly coupled, or they may be indirectly coupled via one or more intermediate components. Any reference signs in the claims should not be construed as limiting the scope.

1. A lyophilisate container comprising;
a compartment;
a wall limiting the compartment; and
a lyophilisate arranged inside the compartment,
wherein at least a portion of the wall is semipermeable allowing vapour permeation in one direction out of the compartment through the wall and preventing vapour permeation in an opposite direction into the compartment through the wall.

2. The lyophilisate container of claim 1, wherein the wall comprises a semipermeable membrane which is vapour permeable in the one direction and vapour tight in the opposite direction.

3. The lyophilisate container of claim 2, wherein the wall comprises a frame structure by means of which the semipermeable membrane is spanned.

4. The lyophilisate container of claim 1, comprising an outer encasing and an inner encasing positioned inside the outer encasing, wherein the wall is a portion of the inner encasing.

5. The lyophilisate container of claim 4, wherein the compartment is arranged in between the outer encasing and the inner encasing, and the at least a portion of the wall is oriented to allow vapour permeation in the one direction from the compartment to the inner encasing through the wall and to prevent vapour permeation in the opposite direction from the inner encasing to the compartment through the wall.

6. The lyophilisate container of claim 4, wherein the compartment is arranged in the inner encasing, and the at least a portion of the wall is oriented to allow vapour permeation in the one direction from the compartment to between the outer encasing and the inner encasing through the wall and to prevent vapour permeation in the opposite direction from between the outer encasing and the inner encasing to the compartment through the wall.

7. The lyophilisate container of claim 4, wherein the outer encasing or the inner encasing has a conical lateral area.

8. The lyophilisate container of claim 2, comprising a rigid body having a hole opening at one end side of the body and extending from the one end side of the body to the an other end side of the body, wherein the hole forms the compartment and the semipermeable membrane is attached to the body thereby closing the hole at the one end side of the body.

9. The lyophilisate container of claim 8, comprising a non-permeable foil having a high thermal conductivity, wherein the foil is attached to the body thereby closing the hole at the other end side of the body.

10. The lyophilisate container of claim 8, wherein the body has a conical lateral area.

11. The lyophilisate container of claim 1, being a pad-like structure, wherein the compartment is formed in between two sheets and at least one of the two sheets is the wall.

12. The lyophilisate container of claim 1, wherein the lyophilisate is a lyophilised drug formulation.

13. An infusion kit comprising a lyophilisate container according to claim 1, a lyophilised drug formulation positioned in the lyophilisate container and a flexible container having a first compartment filled with a reconstitution liquid and a port, in particular, the flexible container comprises a second compartment separated from the first compartment by a frangible seal and the lyophilisate container is arranged inside the second compartment of the flexible container, more particular, the lyophilisate container is embodied in the port of the flexible container.

14. The infusion kit of claim 13, wherein the port has a first mounting structure and the lyophilisate container has a corresponding second mounting structure such that the lyophilisate container is mountable to the body of the flexible container to expel the liquid through the lyophilisate container.

15. A method of preparing a lyophilisate container according to claim 1, comprising:
positioning a moist substance inside a compartment of the lyophilisate container limited by a wall limiting the compartment, wherein at least a portion of the wall is semipermeable allowing vapour permeation in one direction out of the inside of the compartment through the wall and preventing vapour permeation in an opposite direction into the inside of the compartment through the wall;
closing the compartment of the lyophilisate container; and
lyophilising the moist substance in the compartment such that vapour permeates out of the inside of the compartment through the wall.

16. A method comprising the steps of:
obtaining a lyophilisate container according to claim 1,
reconstituting the lyophilisate of the lyophilisate container in a liquid inside the compartment of the lyophilisate container, and
filtering the liquid solution comprising the reconstituted lyophilisate through the wall of the compartment.

17. The lyophilizate container of claim 12, wherein the lyophilizate is a highly potent drug formulation.

18. The lyophilizate container of claim 12, wherein the lyophilised drug formulation comprises a biological component.
